(19) United States
(12) Patent Application Publication
(10) Pub. No.: US 2007/0051851 A1
(43) Pub. Date: Mar. 8, 2007

(54) MULTI-PIECE FASTENER FOR LIMITED CLEARANCE APPLICATIONS

(75) Inventors: Antonio C. Ruffin, Seattle, WA (US); John R. Porter, Lynnwood, WA (US)

Correspondence Address: OSTRAGER CHONG FLAHERTY & BROITMAN, P.C., 250 PARK AVENUE, SUITE 825, NEW YORK, NY, 10177-0899, US

(73) Assignee: THE BOEING COMPANY, Chicago, IL (US)

(21) Appl. No.: 11/162,260

(22) Filed: Sep. 2, 2005

(51) Int. Cl. B64C 1/06

(52) U.S. Cl. 244/131

(57) ABSTRACT

In accordance with the present invention an aerospace wing side-of-body joint assembly is provided comprising at least one chord element, having an internal reduced clearance region, and at least one skin element. At least one cylindrical bolt assembly passes through the chord element and the skin element and secures them together. The cylindrical bolt assembly is comprised of a cylindrical stud having a threaded tail section and a threaded head section protruding into the internal reduced clearance region. A threaded head fastener inserted into the internal reduced clearance region engages the threaded head section. A nut element engages the threaded tail section and is used to introduce a torque without rotating the cylindrical stud.

### TECHNICAL FIELD

The present invention relates generally to a method and apparatus for improving installation of joint elements in limited clearance situations, and more particularly to a method and apparatus utilizing a multi-piece fastener to secure joint elements.

### BACKGROUND OF THE INVENTION

Aerospace and military applications often provide unique challenges to design and manufacturing. Often manufacturing requires the assembly of multiple elements within regions providing limited clearance and reduced accessibility. Traditional attachment methodologies and fasteners may be difficult to position within such regions. In addition, assembly of such structures commonly requires precise tensioning of such fasteners to minimize stresses and insure proper functioning. The use of traditional fasteners, such as commonly used bolt assemblies, can result in difficult installation, ergonomic issues, inconsistent torque application, and sub-optimum joint fatigue performance.

One such assembly that suffers from the aforementioned concerns is the wing side-of-body joint assembly used in aerospace applications. The wing side-of-body joint is configured around chordwise stiffeners, typically referred to as chords, used to transmit wing skin and stringer loads into the body and wing center structure. Presently, the fasteners used in this application are high strength protruding head bolts and nuts. The limited clearance present in the chord elements, however, dictates undesirable constraints on how the bolts may be orientated and their installation sequence. Often, limited clearance may make traditional bolt assemblies virtually impossible to utilize or re-torque after installation.

It is also highly desirable to torque bolts from the nut side. Such nut-side torque application is known to deliver consistent optimum joint fatigue performance. Torque application from the head side often results in the bolt turning inside the hole, which can score the bolt and/or fastener and result in galling and improper bolt tensioning. Therefore, it is highly desirable for the fastener assemblies utilized in the wing side-of-body joint assembly to be torqued from the nut side. The limited clearance imposed by the chord elements, however, makes such nut-side torque application unfeasible in certain locations.

What is needed is a method and fastener assembly that is suited for assembly within reduced clearance regions of the joint assembly. Additionally, it would be highly desirable to have a method and fastener assembly that would allow for nut-side only torque application even within such reduced clearance regions.

### SUMMARY OF THE INVENTION

In accordance with the present invention an aerospace wing side body joint assembly is provided comprising at least one chord element, having an internal reduced clearance region, and at least one skin element. At least one cylindrical bolt assembly passes through the chord element and the skin element and secures them together. The cylindrical bolt assembly is comprised of a cylindrical stud having a threaded tail section and is used a threaded head section protruding into the internal reduced clearance region. A threaded head fastener inserted into the internal reduced clearance region engages the threaded head section. A nut element engages the threaded tail section and is used to introduce a torque without rotating the cylindrical stud.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an aircraft in accordance with the present invention;

FIG. 2 is a detailed illustration of a wing side-of-body joint assembly for use in the aircraft illustrated in FIG. 1.

FIG. 3 is a detailed illustration of a portion of the wing side-of-body joint assembly illustrated in FIG. 2.

FIGS. 4A-C are detailed illustrations of an assembly of the wing side-of-body joint assembly illustrated in FIG. 2.

FIG. 5A-C are detailed illustrations of an alternate assembly of the wing side-of-body joint assembly illustrated in FIG. 2.

FIG. 6 is a detailed illustration of a cylindrical stud for use in the wing side-of-body joint assembly illustrated in FIG. 2.

FIG. 7 is a detailed illustration of an alternate cylindrical stud for use in the wing side-of-body joint assembly illustrated in FIG. 2.

FIG. 8 is a detailed illustration of an alternate cylindrical stud for use in the wing side-of-body joint assembly illustrated in FIG. 2.

### DESCRIPTION OF PREFERRED EMBODIMENTS

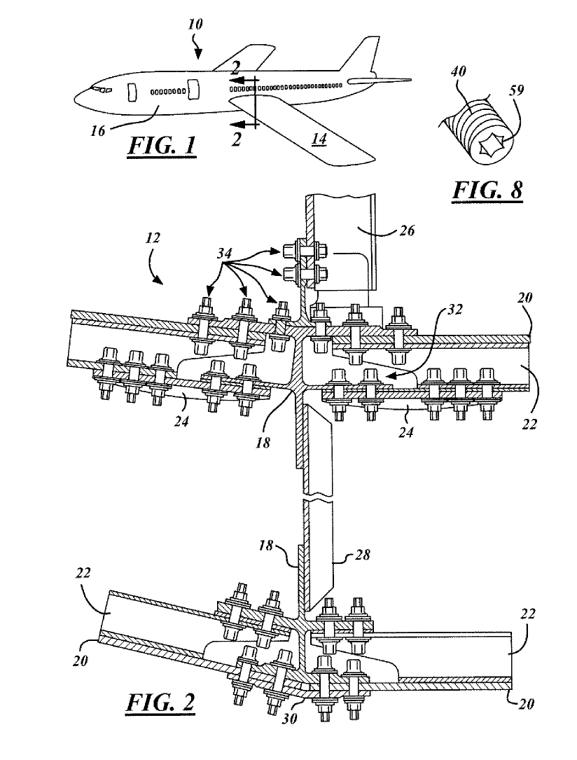

Referring now to FIG. 1, which is an illustration of an aircraft 10 in accordance with the present invention. The aircraft 10 is comprised of a plurality of joint assemblies wherein traditional fastening and assembly techniques may unfeasible or cost prohibitive. One such joint assembly is referred to as the wing side-of-body joint assembly 12, see FIG. 2. The wing side-of-body joint assembly 12 is located where the wing 14 joints the aircraft body side 16. This joint assembly 12 is very important as it is used to join a variety of structures together to form a reliable joint that is preferably highly resistant to joint fatigue.

As illustrated in FIG. 2, the joint assembly 12 is used to join a variety of different structures. Aluminum or titanium chords 18, also referred to as a first joint element, are utilized to join primary structures such as aluminum or carbon fiber-reinforced composite skin elements 20, also referred to as a second joint element, stringers 22, stringer fittings 24, and body frames 26. In addition, the chords 18 are utilized to affix additional stiffeners such as body web stiffeners 28 and spice plates 30. Thus the joint assembly 12 joins a wide plurality of structures and must do so reliably and efficiently.

An issue often arises with such joint assemblies 12 when joint elements such as the chord elements 18 are configured to produce internal reduced clearance regions 32. As can be visually seen in FIG. 2, when such chord elements 18 have such reduced clearance regions 32 in addition to being fastened on multiple sides, the ability to position traditional headed bolts into the reduced clearance region 32 may be difficult or impossible. In addition, the ability to nut-side tighten to prevent bolt rotation may be increasingly difficult with existing designs. The present invention, however, utilizes a special cylindrical bolt assembly 34 to allow simplified joint assembly and reliable nut side torque application.

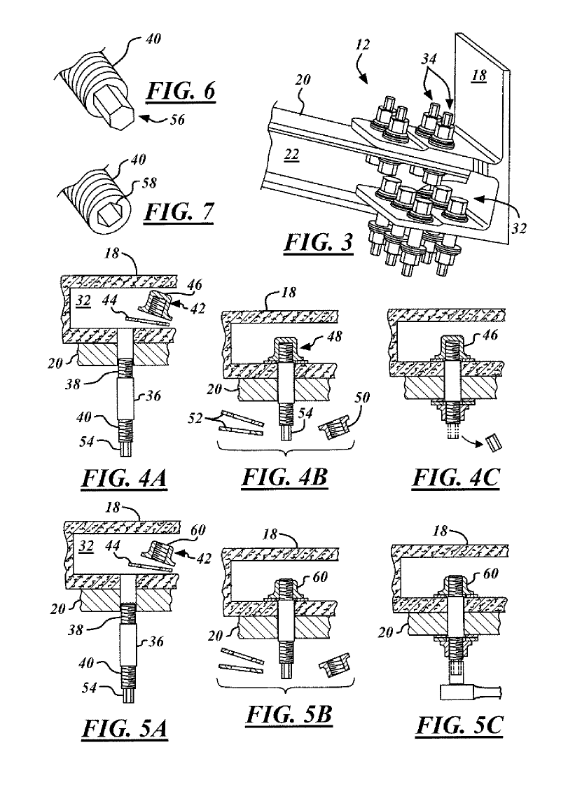

A simplified detail of the joint assembly 12 is illustrated in FIGS. 3 and 4A-C. The present cylindrical bolt assemblies 34 are comprised of a cylindrical stud 36 having a threaded head section 38 and a threaded tail section 40. The threaded head section 38 allows the cylindrical stud 36 to be pushed from outside the reduced clearance region 32 through both the chord 18 and skin 20. This way, only a threaded head fastener 42, and possibly head washers 44, need be navigated into the reduced clearance region 32 rather than an entire bolt assembly. This drastically reduces assembly difficulties. In addition, the present invention contemplates the use of a cap nut 46 as the threaded head fastener 42. The cap nut 46 may be tightened down against the cylindrical stud 36 until the end of the stud 36 on the threaded head section 38 contacts the bottom of the cap nut 46, thus limiting further rotation of the nut 46 and forming a rigid fastener head 48. A crimp or non-metallic insert in the cap nut 46 ensures that the nut 46 remains firmly locked in place after the fastener installation is complete. In this fashion, all the benefits of a traditional solid head bolt are achieved without the assembly difficulties. A nut element 50, in combination with tail washers 52, may be torqued onto the cylindrical stud 36 without rotation of the stud by restraining rotation of the cap nut 46 with a conventional wrench.

Although the formation of a rigid fastener head 48, as described above, will preclude stud rotation during installation of the nut element 50, the present invention further contemplates the use of a wrenching features 54 formed on the threaded tail section 40. The wrenching feature 54 is intended to encompass a wide variety of features capable of restraining rotation of the cylindrical stud 36 without requiring access to the threaded head fastener 42. These include, but are not limited to, prismatic extensions 56 as shown in FIG. 6, hexagonal recesses 58 as shown in FIG. 7, and spline recesses 59 as shown in FIG. 8. The wrenching features are restrained with a corresponding wrench or key to secure the cylindrical stud 36 while torque is applied purely to the nut element 50.

In addition, the wrenching feature 54 allows for the use of an open head nut 60 as the threaded head fastener 42, as shown in FIGS. 5A-5C. The open head nut 60 is threaded onto the threaded head section 38 until the desired threat protrusion level is achieved. Thread protrusion is the length of thread from the threaded head section 38 projecting past the nut 60 as it is installed, and is commonly used as a means to ensure proper engagement of typical bolt and nut elements. During this operation, rotation of the stud 36 is prevented by reacting the nut 60 locking torque at the wrenching feature 54. Installation of the nut element 50 is then accomplished by applying a torque to the nut element 50 and using the wrenching feature 54 to keep the stud 36 from rotating. This allows for a standard nut to be utilized as the threaded head fastener 42 which may reduce cost and simplify disassembly should it be desirable. Finally, as an added feature to reduce weight or further conserve space, the wrenching feature 54 may be frangible as shown in FIG. 4C. This means that after its use to restrain the cylindrical stud 36 while torque is applied to the nut element 50, the wrenching feature 54 may be broken off to reduce weight or improve accessibility to other joint regions.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An aerospace wing side-of-body joint assembly comprising:
at least one chord element comprising an internal reduced clearance region;
at least one skin element;
at least one cylindrical bolt assembly passing through said at least one chord element and said at least one skin element, said at least one cylindrical bolt assembly affixing said at least one skin element to said at least one chord element, said cylindrical bolt assembly comprising:
a cylindrical stud comprising a threaded head section and a threaded tail section, said threaded head section protruding into said internal reduced clearance region;
a threaded head fastener inserted into said internal reduced clearance region and secured to said threaded head section;
a nut element engaged to said threaded tail section, said nut element allowing torque to be applied to said cylindrical bolt assembly through said nut element without rotating said cylindrical stud.

2. An aerospace wing side-of-body joint assembly as described in claim 1, wherein said threaded head fastener comprises a cap nut.

3. An aerospace wing side-of-body joint assembly as described in claim 2, wherein said cap nut is configured to lock-in to said threaded head section to form a rigid fastener head.

4. An aerospace wing side-of-body joint assembly as described in claim 1, further comprising:
a wrenching feature adjacent said threaded tail section, said wrenching feature allowing said cylindrical stud to be restrained at said threaded tail section while torque is applied to said nut element.

5. An aerospace wing side-of-body joint assembly as described in claim 4, wherein said wrenching feature comprises a prismatic extension protruding from said threaded tail section.

6. An aerospace wing side-of-body joint assembly as described in claim 1, wherein said wrenching feature comprises a hexagonal recess formed in a bottom surface of said threaded tail section.

7. An aerospace wing side-of-body joint assembly as described in claim 1, wherein said wrenching feature comprises a spline recess formed in a bottom surface of said threaded tail section.

8. An aerospace wing side-of-body joint assembly as described in claim 4, wherein said wrenching feature comprises an extension protruding from said threaded tail section, said extension comprising a frangible extension such that said extension may be removed after torque is applied to said nut element.

9. An aerospace wing side-of-body joint assembly as described in claim 1, wherein said cylindrical bolt assembly further secures a stringer assembly to said at least one chord element.

10. An aerospace joint assembly comprising:
a first joint element comprising an internal reduced clearance region;
a second element;
at least one cylindrical bolt assembly passing through said first joint element and said second joint element, said at least one cylindrical bolt assembly affixing said first joint element to said second joint element, said cylindrical bolt assembly comprising:
a cylindrical stud comprising a threaded head section and a threaded tail section, said threaded head section protruding into said internal reduced clearance region;
a threaded head fastener inserted into said internal reduced clearance region and secured to said threaded head section;
a nut element engaged to said threaded tail section, said nut element allowing torque to be applied to said cylindrical bolt assembly through said nut element without rotating said cylindrical stud; and
a wrenching feature adjacent said threaded tail section, said wrenching feature allowing said cylindrical stud to be restrained at said threaded tail section while torque is applied to said nut element.

11. An aerospace joint assembly as described in claim 1, wherein said threaded head fastener comprises a cap nut.

12. An aerospace joint assembly as described in claim 1, wherein said threaded head fastener comprises an open-end head nut.

13. An aerospace joint assembly as described in claim 11, wherein said cap nut is configured to lock-in to said threaded head section to form rigid fastener head.

14. An aerospace joint assembly as described in claim 10, wherein said wrenching feature comprises a prismatic extension protruding from said threaded tail section.

15. An aerospace joint assembly as described in claim 10, wherein said wrenching feature comprises a hexagonal recess formed in a bottom surface of said threaded tail section.

16. An aerospace joint assembly as described in claim 10, wherein said wrenching feature comprises a spline recess formed in a bottom surface of said threaded tail section.

17. An aerospace joint assembly as described in claim 10, wherein said wrenching feature comprises an extension protruding from said threaded tail section, said extension comprising a frangible extension such that said extension may be removed after torque is applied to said nut element.

18. An aerospace joint assembly as described in claim 10, wherein said first joint element comprises a chord element; and
said second joint element comprises a wing skin element.

19. A method of assembling an aerospace wing side-of-body joint assembly comprising:
inserting a cylindrical stud through a skin element and a chord element, said cylindrical stud comprising a threaded head section and a threaded tail section, said threaded head section protruding into an internal reduced clearance section of said chord element;
inserting a threaded head fastener into said internal reduced clearance section;
engaging said threaded head fastener with said threaded head section;
mounting a nut element to said threaded tail section;
applying torque to said nut element wherein said skin element is secured against said chord element without rotating said cylindrical stud.

20. A method as described in claim 18, further comprising:
tightening a cap nut to said threaded head section until said cap nut locks-in to said threaded head section to form a rigid fastener head, said threaded head fastener comprising said cap nut.

21. A method as described in claim 18, further comprising:
securing said cylindrical stud during application of torque to said nut element, said cylindrical stud secured using a wrenching feature adjacent to said threaded tail section.

22. A method as described in claim 20, wherein said wrenching feature comprises a prismatic extension protruding from said threaded tail section.

23. A method as described in claim 20, wherein said wrenching feature comprises a hexagonal recess formed in a bottom surface of said threaded tail section.

24. A method as described in claim 20, wherein said wrenching feature comprises a spline recess formed in a bottom surface of said threaded tail section.

25. A method as described in claim 20, further comprising:
breaking off said wrenching feature after application of torque to said nut element.
